(19) United States
(12) Patent Application Publication
(10) Pub. No.: US 2024/0240088 A1
(43) Pub. Date: Jul. 18, 2024

(54) FLAME RETARDANT POLYMERS AND PROCESSES FOR PRODUCING AND USING THE SAME

(71) Applicant: ARIZONA BOARD OF REGENTS ON BEHALF OF THE UNIVERSITY OF ARIZONA, Tuscon, AZ (US)

(72) Inventors: Dong Chul Pyun, Tucson, AZ (US); Robert Norwood, Tucson, AZ (US); Jon Njardarson, Tucson, AZ (US); Richard Glass, Tucson, AZ (US); Taeheon Lee, Tucson, AZ (US); Chisom Olikagu, Tucson, AZ (US); Kyung-Seok Kang, Tucson, AZ (US)

(73) Assignee: ARIZONA BOARD OF REGENTS ON BEHALF OF THE UNIVERSITY OF ARIZONA, Tuscon, AZ (US)

(21) Appl. No.: 18/598,889

(22) Filed: Mar. 7, 2024

Related U.S. Application Data
(63) Continuation of application No. PCT/US2022/043363, filed on Sep. 13, 2022.
(60) Provisional application No. 63/244,128, filed on Sep. 14, 2021.
(60) Provisional application No. 63/348,774, filed on Jun. 3, 2022.

(51) Int. Cl. C09K 21/14; C08G 75/16; C08G 79/00; C08L 81/04; C08L 85/00

(52) U.S. Cl. CPC C09K 21/14; C08G 75/16; C08G 79/00; C08L 81/04; C08L 85/00; C08L 2201/02

(57) ABSTRACT

A flame retardant composition includes a polymers that is the reaction product of a mixture of a chalcogenide halide and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof.

### CROSS-REFERENCE TO RELATED APPLICATIONS

This application is a continuation of PCT/US2022/043363, filed on Sep. 13, 2022, which claims the benefit of priority to U.S. Provisional Application No. 63/348,774, filed Jun. 3, 2022 and to U.S. Provisional Application No. 63/244,128, filed Sep. 14, 2021, all of which are hereby incorporated by reference in their entireties.

### FIELD

The present invention relates to a method for producing sulfur-containing polymers (e.g., organochalcogenide polymers). In particular, the present invention provides a method for producing sulfur-containing polymers that are useful for flame-retardancy.

### BACKGROUND

Synthetic plastics are a critical class of materials in modern society due to their low cost, excellent thermomechanical properties, and wide fields of use. However, an intrinsic hazard associated with plastics is the flammability of these materials, which is exacerbated by their proximity to ignitable consumer products in residential housing, transportation, and electronic packaging. To impart flame retardancy to plastics three primary approaches have been utilized: (a) addition of flame retardant (FR) additives to conventional plastics (b) protective coatings (c) the synthesis of novel intrinsically flame-retardant polymers.

Small molecule FR additives, which include halogenated compounds, such as, decabromodiphenyl ether (DBDPE) tetrabromobisphenol A (Br₄BPA), or hexachloropentadiene derived cyclic olefins these compounds, are highly effective fire mitigation agents for plastics. However, these halogenated FR agents have been under considerable scrutiny and regulation over concerns that these toxic FR additives leach from plastics into the environment resulting in long term persistence and potential bioaccumulation. Inorganic additives, such as clay, or metal hydroxide fillers in plastics are also inexpensive and effective FR agents, but as for all polymer composites, must be added in significant loading to achieve the desired properties. However, the creation of novel low-cost FR polymers utilizing inexpensive reagents is an intriguing opportunity for academic researchers to tackle this problem by the invention, or application of new polymerization chemistry to prepare these types of materials.

A classical approach to FR polymers is the copolymerization of monomers modified with small molecule FR functional groups. While these materials have been demonstrated to minimize heat release during combustion, the higher cost associated with these reagents, namely, based on organophosphorus chemistry, has limited large scale production of these materials. Furthermore, in all for these approaches, the emphasis is on incorporation of FR moieties into existing polymeric materials (e.g., polyurethanes, polyesters), versus discovery of new intrinsically FR active monomers and polymers. As such, there remains a need for new monomer feedstock and polymer chemistry to make improved FR polymers.

These disclosure provides flame retardant composition comprising a polymer (e.g., a sulfur containing polymer) that is a reaction product of a mixture of a chalcogenide halide and one or more organic compounds comprising an unsaturated carbon-carbon bond under reaction conditions sufficient to produce the polymer.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY

Provided herein are flame retardant compositions that include the sulfur compositions or polymeric compositions described herein. In some embodiments, the sulfur compositions described herein have higher char yields than other synthetic polymers and/or may be more effective flame retardant that is non-halogenated. Further, in some embodiments, the compositions described herein allow for the direct use of low cost sulfur to form inexpensive high sulfur content copolymers that can promote a high carbon char content. Furthermore, the sulfur copolymers described herein are readily used in solution, or melt processed into thin films, coatings, or blends for use as a flame retardant.

Some aspects of the invention relate to processes for producing organochalcogenide polymers without using molten sulfur. In particular, some aspects of the invention provide processes for producing organochalcogen polymers at a relatively lower temperature compared to conventional methods that involve use of molten sulfur, which require high temperatures, e.g., 120° C. to 180° C. or higher.

Another limitation of conventional methods is that elemental sulfur or molten sulfur has limited miscibility with organic comonomers. In contrast, methods of the invention use chalcogenide sources that are miscible with organic comonomers.

Provided in one aspect is a flame retardant composition comprising a polymer (e.g., a sulfur containing polymer) that is a reaction product of a mixture of a chalcogenide halide and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof.

In some embodiments, the chalcogenide halide is selected from the group consisting of sulfur monochloride, sulfur monobromide, selenium monochloride, selenium monobromide, selenium dichloride, selenium dibromide, selenium tetrachloride, selenium tetrabromide, and a combination of any two or more thereof. In some embodiments, the chalcogenide halide is sulfur monochloride.

In some embodiments, the unsaturated carbon-carbon bond comprises a carbon-carbon double bond, a carbon-carbon triple bond, or a combination of any two or more thereof. In some embodiments, the organic compound comprises at least two unsaturated carbon-carbon bonds. In some embodiments, the organic compound comprises at least three unsaturated carbon-carbon bonds.

In some embodiments, the organic compound comprises a vinyl olefin, an allyl olefin, a styrenic olefin, an α-methylstyrenic olefin, a (meth)acrylate olefin, a norbornene, a cyclic olefin, a vinylogous sulfide, a substituted alkene olefin, a maleimide, a maleic anhydride, or a combination of any two or more thereof.

In some embodiments, the organic compound comprises a terephthalate, an isophthalate, a bisphenol A or derivative thereof, 4,4-methylene diphenyl (MDI), a trifunctional terephthalate, a tris-phenolic core, a isocyanurate, a phosphazene, a siloxane, a isocorbide, a naturally occurring product, or a combination of any two or more thereof. In some embodiments, the organic compound comprises a terephthalate, an isophthalate, a bisphenol A or derivative thereof, 4,4-methylene diphenyl (MDI), a trifunctional terephthalate, a tris-phenolic core, a isocyanurate, or a combination of any two or more thereof. In some embodiments, the organic compound comprises 1,3-diallyl isophthalate (DAI), diallyl tetrabromo-bisphenol A (DABr₄BPA), triallyl isocyanurate (TIC), or a combination of any two or more thereof.

In some embodiments, the polymer is produced by a process comprising admixing a monomeric mixture comprising the chalcogenide halide and the one or more organic compound comprising an unsaturated carbon-carbon bond under suitable reaction conditions. In some embodiments, the monomeric mixture is admixed in the presence of an organic solvent.

In some embodiments, the organic solvent comprises a polar organic solvent, a non-polar aprotic organic solvent, or a combination of any two or more thereof. In some embodiments, the organic solvent comprises tetrahydrofuran, toluene, benzene, xylene, chlorobenzene, dichlorobenzene, diethyl glycol, N,Ndimethylformamide, carbon disulfide, halogenated solvents such as dichloromethane, chloroform, or a combination of any two or more thereof.

In some embodiments, the process is conducted at a reaction temperature of about 200° C. or less or about 100° C. or less. In some embodiments, the process is conducted at a reaction temperature of from about 50° C. to about 100° C. In some embodiments, the process is conducted at a reaction temperature of from about 65° C. to about 75° C.

In some embodiments, the polymer has a number averaged molecular weight (Mn) of about 50,000 or greater, about 80,000 or greater, or about 100,000 or greater.

In some embodiments, the monomeric mixture further comprises one or more elemental sulfur derived copolymers, such as a poly(sulfur-random-styrene).

In some embodiments, when a substrate combined with any one of the flame retardant composition described herein is ignited to be on fire, the fire retardant composition forms a charring layer on a surface of the substrate that is effective for extinguishing the fire.

In some embodiments, the charring layer comprises at least about 10 wt % char. In some embodiments, the flame retardant composition provides for test specimens that are combined with the flame retardant composition to exhibit a limiting oxygen index (LOI) of at least 25 and/or a UL94-V rating of V-2, V-1 or V-0.

In some embodiments, any one of the flame retardant compositions described herein further comprises a flame retardant filler to enhance char formation.

In some embodiments, for any one of the flame retardant compositions described herein, the polymer is used as a flame retardant (FR) agent, wherein the polymer is intrinsically a FR polymer, or the polymer may be further blended with a flammable polymer, or the polymer is a FR coating onto a flammable polymer.

Provided in one aspect is a flame resistant substrate comprising a base material combined with the any one of the flame retardant composition described herein.

In some embodiments, the flame retardant composition forms a fire retardant intumescent coating on a surface of the base material.

Also, provided herein is the use of a flame retardant composition of any one of the compositions described herein for preventing or slowing the spread of fire.

Provided in one aspect is a process for producing any one of the flame retardant compositions described herein, comprising admixing a monomeric mixture comprising a chalcogenide halide and an organic compound comprising an unsaturated carbon-carbon bond under reaction conditions sufficient to produce a polymer, wherein said chalcogenide halide comprises a sulfur monohalide, a sulfur dihalide, a selenium monohalide, a selenium dihalide, a selenium tetrahalide, or a combination of any two or more thereof.

In some embodiments, the process further comprises purifying the polymer. In some embodiments, purifying the polymer comprises the steps of: (a) dissolving the polymer in an organic solvent to produce a homogeneous solution; (b) precipitating said the polymer to produce at least a partially purified the polymer; and (c) optionally repeating steps (a) and (b).

In some embodiments, the polymer has a purity of at least about 90%, including about 90%, about 91%, about 92%, about 93%, about 94%, about 95%, about 96%, about 97%, about 98%, and about 99%.

In some embodiments, the polymer has a low heat release capacity (e.g., <400 J/gK). In some embodiments, the polymer exhibits a UL94-V rating of V-2, V-1, or V-0. In some embodiments, the polymer exhibits a vapor phase flame retardant mechanism.

One particular aspect of the invention provides a method for producing organochalcogen polymers using a chalcogen halide. One of the differences of methods of the invention relative to conventional methods is the lower total incorporation of chalcogenide moieties (e.g., disulfide S—S vs longer chains SS bonds), which may affect other bulk properties.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be constructed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the term “char” is defined as a carbonaceous residue resulting from the conversion of an organic matter, usually through pyrolysis. Char formation results from the action of substances that are able to reticulate a burning substrate and to create a charring insulating layer.

As used herein, the term “intumescence” is defined as a mechanism that creates a foamed charring structure that forms a barrier to prevent flame and oxygen from reaching a substrate. Typically, an intumescent substance will swell as a result of heat exposure, thus increasing in volume and decreasing in density. When heated, an intumescent can produce charring.

As used herein, the terms “those defined above” and “those defined herein” when referring to a variable incorporates by reference the broad definition of the variable as well as any narrow and/or preferred definitions, if any.

Described herein are flame retardant compositions that include the polymers described herein. In some embodiments, the polymers or compositions described herein have higher char yields than other synthetic polymers and/or may be more effective flame retardant that is non-halogenated. Further, in some embodiments, the compositions described herein form inexpensive high sulfur content copolymers that can promote a high carbon char content. Furthermore, the polymers described herein are readily used in solution, or melt processed into thin films, coatings, or blends for use as a flame retardant.

The sulfur-containing polymers (e.g. organochalcogen polymers) described herein are prepared without using molten sulfur or a reaction temperature that is typical of conventional organochalcogen polymer synthesis. In particular, methods of the invention utilize a chalcogen halide to produce organochalcogen polymers under a significantly lower reaction temperature. Furthermore, unlike elemental sulfur the reagents used in methods of the invention are miscible in organic solvents, thereby allowing case of processing in both reaction and purification step compared to conventional methods using molten sulfur.

It should be appreciated that while the present invention is described with regard to producing sulfur-organochalcogen polymers, which assist in illustrating various features of the invention, the scope of the invention is not limited to sulfur-containing organochalcogen polymers but includes organochalcogen polymers containing sulfur, selenium, tellurium, and a combination of two or more thereof. In this regard, the present invention generally relates to producing organochalcogen polymers such as organochalcogen polymers containing sulfur, selenium, tellurium, or a mixture thereof. In particular, methods for producing sulfur-containing organochalcogen polymers are disclosed herein.

Provided in another aspect is a composition comprising a polymer (e.g., organochalcogen polymer) that is a reaction product of a mixture of a chalcogenide halide or a and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof.

Accordingly, while the remainder of the present disclosure is directed to a method for producing various sulfur-containing polymers (e.g., organochalcogen polymers), one skilled in the art having read the present disclosure can readily recognize that the scope of the invention is not limited to sulfur-containing organochalcogen polymers but includes other organochalcogen polymers such as those containing, sulfur, selenium, tellurium, and a mixture thereof. Synthesis of other organochalcogen polymers can be readily achieved, for example, by replacing a sulfur halide with a selenium halide, tellurium halide, or a mixture there.

Accordingly, the following discussion for methods for producing sulfur containing organochalcogen polymers is provided solely for the purpose of illustrating the practice of the invention and does not constitute limitations on the scope of the present invention.

Some aspects of the invention provide methods and processes for producing organochalcogen polymers using a chalcogen halide, such as, but not limited to, sulfur halide (e.g., sulfur mono- or di-halide), selenium halide (e.g., selenium mono-, di-, or tetrahalide), tellurium halide, or a combination thereof.

Methods and processes of the invention include using sulfenyl chloride molecular compounds, functional polymers and chalcogenide halide monomers for the synthesis of new polymeric materials. In one particular example, sulfur monochloride (S₂Cl₂) is copolymerized with unsaturated organic monomers. As used herein, the term “unsaturated organic monomer” refers to an organic compound having one or more carbon-carbon double or carbon-carbon triple bonds. In some embodiments, the organic compound comprises at least two unsaturated carbon-carbon bonds. In some embodiments, the organic compound comprises at least three unsaturated carbon-carbon bonds. Exemplary organic comonomers include ethylenically unsaturated monomers, vinylic monomers, cyclic olefins (such as norbornenes, other bicyclic olefins), alkynes, styrenics, methacrylate, allylics, norbornenes, cyclic olefins, substitutes alkenes, vinylogous sulfides, alkynes, maleimides, maleic anhydride, as well as polymers and oligomers carrying these polymerizable groups.

Other suitable organic monomers include organic compounds with classical step-growth polymerization core monomers based on, for example, terephthalates, isophthalates, bisphenol A and BPA derivatives, 4,4-methylene diphenyl (MDI), trifunctional terephthalates, tris-phenolic cores, isocyanurates, phosphazenes, siloxanes, isocorbides, naturally occurring products. In some embodiments, the organic compound comprises a terephthalate, an isophthalate, a bisphenol A or derivative thereof, 4,4-methylene diphenyl (MDI), a trifunctional terephthalate, a tris-phenolic core, a isocyanurate, a phosphazene, a siloxane, a isocorbide, a naturally occurring product, or a combination of any two or more thereof. In some embodiments, the organic compound comprises a terephthalate, an isophthalate, a bisphenol A or derivative thereof, 4,4-methylene diphenyl (MDI), a trifunctional terephthalate, a tris-phenolic core, an isocyanurate, or a combination of any two or more thereof. In some embodiments, the organic compound comprises 1,3-diallyl isophthalate (DAI), diallyl tetrabromo-bisphenol A (DABr₄BPA), triallyl isocyanurate (TIC), or a combination of any two or more thereof. Other contemplated organic compounds include but are not limited to cycloalkane diacid/diesters, including cyclohexane diacids/diesters, napthalate diester monomers, aromatic and cycloalkane carbamate monomers with diallyl groups, triazines and isocyanurate triallyl monomers. In some embodiments, the organic compound comprises a cycloalkane diacid/diester, including cyclohexane diacid/diester, napthalate diester monomer, aromatic and cycloalkane carbamate monomer with an diallyl group, triazine and isocyanurate triallyl monomer. In general, the scope of the invention includes any and all organic monomer that include one or more carbon-carbon unsaturated bonds that can react with the chalcogen halide. In some embodiments, the carbon-carbon unsaturated bond comprises a carbon-carbon double bond, a carbon-carbon triple bond, or a combination of any two or more thereof.

The addition of sulfur-chlorine, sulfur-bromine and/or selenium chloride, selenium bromine, tellurium chloride, tellurium bromide groups result in what are generally referred to as “chalcogenide halides”, which are organic solvent soluble chemicals that are extremely reactive toward alkenes and other unsaturated monomers. Without being bound by any theory, it is believed that this strong reactivity creates a driving force for polymerization while also allowing these reactions to be done in organic solvent solutions at lower temperature (e.g., reaction temperature of as low as −78° C.) to room temperature, or above. This is in stark contrast to the inverse vulcanization process using liquid or molten sulfur, which must be done at high temperatures in neat, liquid or molten sulfur media, which has very limited solubility/miscibility with most conventional organic comonomers.

Methods and processes of the invention generally can be referred to as a direct copolymerization of S₂Cl₂ with olefins and alkynes, which is referred to herein as “Chalcogenide Halide Inverse Vulcanization” or “Sulfenyl Chloride Inverse Vulcanization.” In some embodiments, methods of the invention allow polymerization of disulfide (i.e., two S—S bonds) or diselenide per monomer unit. In some embodiments, organochalcogen polymers produced using methods of the invention have a lower sulfur (selenium or tellurium) content than the inverse vulcanization using, for example molten or liquefied sulfur. However, the higher reactivity and a significantly higher solubility of chalcogen halide (e.g., S₂Cl₂) compared to liquid sulfur enables ease of processing (e.g., isolation and/or purification) of the organochalcogen polymers that are produced using methods of the invention.

Methods of the invention include admixing a monomeric mixture comprising: (i) a chalcogenide halide and (ii) one or more organic compounds comprising an unsaturated carbon-carbon bond under reaction conditions sufficient to produce said organochalcogenide polymer. The chalcogenide halide is selected from the group consisting of sulfur monohalide, sulfur dihalide, selenium monohalide, selenium dihalide, selenium tetrahalide, and a combination thereof.

In some embodiments, said chalcogenide halide is selected from the group consisting of sulfur monochloride, sulfur dichloride, sulfur monobromide, selenium monochloride, selenium monobromide, selenium dichloride, selenium dibromide, selenium tetrachloride, selenium tetrabromide and a combination thereof. Still in other embodiments, said chalcogenide halide is selected from the group consisting of sulfur monochloride, sulfur dichloride, selenium monochloride, selenium dichloride, selenium tetrachloride, and a combination thereof.

In some embodiments, said monomeric mixture is admixed in the presence of an organic solvent. In some instances, said organic solvent comprises a polar organic solvent, a non-polar aprotic organic solvent, or a combination thereof. Exemplary organic solvents that are useful in methods of the invention include, but are not limited to, tetrahydrofuran, toluene, benzene, xylene, chlorobenzene, dichlorobenzene, diethyl glycol, N,N-dimethylformamide, carbon disulfide, halogenated solvents such as dichloromethane, chloroform and a combination thereof.

In further embodiments, said unsaturated carbon-carbon bond comprises a carbon double bond, a carbon-carbon triple bond, or a combination thereof.

In some embodiments, the polymer (e.g., the organochalcogenide polymer) is produced at a reaction temperature of about 200° C. or less, typically about 150° C. or less, often 100° C. or less, more often about 90° C. or less, and most often about 80° C. or less. In some embodiments, the process is conducted at a reaction temperature of about 200° C. or less or about 100° C. or less. In some embodiments, the process is conducted at a reaction temperature of from about 50° C. to about 100° C. In some embodiments, the process is conducted at a reaction temperature of from about 65° C. to about 75° C. In some embodiments, the process is conducted at a reaction temperature of from about 0° C. to about 50° C.

In further embodiments, an amount of said chalcogenide halide used is about 90 mole % or less, typically about 80 mole % or less, and often about 75 mole % or less relative to an amount of said organic compound.

Other aspects of the invention provide an organochalcogenide polymer produced from a process comprising admixing a monomeric mixture comprising: (i) a chalcogenide halide and (ii) one or more organic compounds comprising an unsaturated carbon-carbon bond under reaction conditions sufficient to produce said organochalcogenide polymer, wherein said chalcogenide halide is selected from the group consisting of sulfur monohalide, selenium monohalide, selenium dihalide, selenium tetrahalide, and a combination thereof.

In some embodiments, the polymer is produced by a process comprising admixing a monomeric mixture comprising the chalcogenide halide and the one or more organic compound comprising an unsaturated carbon-carbon bond under suitable reaction conditions. In some embodiments, the monomeric mixture is admixed in the presence of an organic solvent.

The polymers described herein have high molecular weights. In some embodiments, the polymer has a number averaged molecular weight (Mn) of about 5,000 or greater, about 10,000 or greater, about 50,000 or greater, about 80,000 or greater, about 100,000 or greater about 200,000 or greater, about 300,000 or greater, about 400,000 or greater, about 500,000 or greater, and about 600,000 or greater, including about 5,000, about 10,000, about 50,000, about 60,000, about 70,000, about 80,000, about 90,000, about 100,000, about 110,000, about 120,000, about 150,000, about 200,000, about 300,000, about 400,000, about 500,000 and 600,000. In some embodiments, polymer has a number averaged molecular weight (Mn) of from about 5,000 to about 20,000, from about 10,000 to about 40,000, or from about 30,000 to about 50,000. In some embodiments, polymer has a number averaged molecular weight (Mn) of from about 130,000 to about 300,000 or about 200,000 to about 600,000.

Provided in one aspect is a process for producing any one of the compositions described wherein, comprising admixing a monomeric mixture comprising a chalcogenide halide and an organic compound comprising an unsaturated carbon-carbon bond under reaction conditions sufficient to produce a polymer, wherein said chalcogenide halide comprises a sulfur monohalide, a sulfur dihalide, a selenium monohalide, a selenium dihalide, a selenium tetrahalide, or a combination of any two or more thereof.

In some embodiments, the monomeric mixture further comprises one or more elemental sulfur derived copolymers, such as a poly(sulfur-random-styrene). Examples of such polymers include those described in WO2017011533, WO2013023216, and U.S. Pat. No. 9,567,439, which are incorporated by reference for the disclosure of such compounds.

In some embodiments, the process further comprises purifying the polymer. In some embodiments, purifying the polymer comprises the steps of: (a) dissolving the polymer in an organic solvent to produce a homogeneous solution; (b) precipitating said the polymer to produce at least a partially purified the polymer; and (c) optionally repeating steps (a) and (b).

In some embodiments, methods of the invention provide polymers (e.g., organochalcogenide polymers) having a purity of at least about 80%, typically at least about 85%, often at least about 90%, and more often at least about 95%. In some embodiments, the polymer has a purity of at least about 90%, including about 90%, about 91%, about 92%, about 93%, about 94%, about 95%, about 96%, about 97%, about 98%, and about 99%.

Still in some embodiments, a yield of the polymers described herein (e.g., organochalcogenide polymers) is about 50% or higher, typically about 60% or higher, and often about 70% higher relative to the amount of said organic compound used.

In some embodiments, the polymers produced herein have a low heat release capacity (as determined from microcombustion calorimetry). In some embodiments, the polymers produced herein have a low heat release capacity of less than about 400 J/gK, including less than about 300 J/gK, less than about 200 J/gK, less than about 100 J/gK, and less than about 50 J/gK, as determined from microcombustion calorimetry.

Also, the polymers described here exhibit a vapor phase flame retardancy mechanism, where the sulfur radicals formed quench OH radicals that promote burning, rather than exhibiting an intumescent flame retardancy mechanism, where extinguishment is induced by carbonization. In some embodiments, the polymer exhibits a vapor phase flame retardant mechanism.

In other embodiments, the polymers described herein alone may serve as the flame retardant (FR) agent in any one of the following ways. In some embodiments, the polymers described herein are intrisically FR polymers. In some embodiments, the polymers described herein may be blended with a flammable polymer. In some embodiments, the polymers described herein may be used as a FR coating onto a flammable polymer.

In other embodiments, the compositions described herein may further include binders, fillers, or combinations thereof that are flame retardant and can enhance char formation. Suitable binders include organic binders, inorganic binders, and mixtures of these two types of binders. For example, the organic binders may be provided as a solid, a liquid, a solution, a dispersion, a latex, or similar form. The organic binder may include a thermoplastic or thermoset binder, which after cure is a flexible material. Other embodiments of the filler material may include clay materials, such as bentonite or kaolinite, and fiber materials, such as ceramic fibers and polycrystalline fibers.

In yet another embodiment, the present invention features a method of enhancing char formation in a substrate. The method may include combining a base material with a fire retardant composition to form the substrate. Preferably, the substrate exhibits an LOI of at least 25 and a UL94-V rating of V-2, V-1 or V-0. In other embodiments, the fire retardant composition includes a polymer blend of the thermoplastic polymer and the polymeric composition described herein. In other embodiments, the fire retardant composition includes a polymer blend of the thermoplastic polymer and any one of the polymers described herein. Without wishing to limit the present invention, the fire retardant composition is effective in forming a charring layer on the substrate when the substrate is on fire. The charring layer can extinguish and prevent the fire from spreading. In some embodiments, the charring layer may include at least 20 wt % char. For example, the charring layer may include at least 25 wt % char or 30 wt % char.

In some embodiments, the step of combining the base material with the fire retardant composition includes coating the base material with a coating including the fire retardant composition. In other embodiments, the step of combining the base material with the fire retardant composition includes depositing the fire retardant composition on the surface of the base material. In still other embodiments, the step of combining the base material with the fire retardant composition may include mixing monomers of the base material with monomers of the fire retardant composition to form a co-monomer mixture, polymerizing the co-monomer mixture to form a flame resistant polymer, and molding the flame resistant polymer to a shape of the substrate.

Another embodiment of the present invention may feature a method of forming a flame retardant-treated polymeric article. The method may include providing a polymeric base substrate, providing a flame retardant material comprising any of the flame retardant compositions described herein, and depositing the flame retardant material on at least a portion of an outer surface of the polymeric base substrate to form the flame retardant-treated polymeric article. Preferably, the flame retardant-treated polymeric article provides for test specimens that exhibit an LOI of at least 25 and a UL94-V rating of V-2, V-1 or V-0. Preferably, when the flame retardant-treated polymeric article is on fire, the flame retardant material forms a charring layer on the flame retardant-treated polymeric article to extinguish the fire. The charring layer may include at least 20 wt % char.

Alternate embodiments of the present invention may feature a method of forming a flame resistant composite. The method may include providing a flame retardant material including any of the flame retardant compositions described herein, providing a base material, and mixing the flame retardant material with the base material to form the flame resistant composite. The flame retardant material can enhance char formation when flame resistant composite is on fire. In some embodiments, the composite may include between about 1 to 20 wt % of the flame retardant material. For example, the composite may include about 10 wt % of the flame retardant material. In some embodiments, the base material is a polymeric material.

In some embodiments, when a substrate combined with the fire retardant composition is on fire, the fire retardant composition or polymeric composition can form a charring layer on a surface of the substrate that is effective for extinguishing the fire. In some embodiments, the charring layer includes at least about 10 wt % char or at least about 20 wt % char. In other embodiments, the fire retardant composition or polymeric composition may provide for test specimens that are combined with the fire retardant composition to exhibit a limiting oxygen index (LOI) of at least 25 and a UL94-V rating of V-2, V-1 or V-0. In some embodiments, when E is —C(O)OH, the fire retardant composition or polymeric composition is used as a polyelectrolyte for processing of layer-by-layer (LBL) films with a companion polyelectrolyte of opposite charge to form LBL thin films for flame retardant coatings.

In some embodiments, wherein the fire retardant composition or polymeric composition further includes a flame retardant filler to enhance char formation.

According to some embodiments, the present invention provides a flame resistant substrate comprising a base material combined with any of the fire retardant compositions or polymeric compositions described herein. In one embodiment, the fire retardant composition or polymeric composition forms a fire retardant intumescent coating on a surface of the base material. In another embodiment, the fire retardant composition or polymeric composition is mixed into the base material.

In one embodiment, the fire retardant composition includes a polymeric blend of at least about 50 wt % of a thermoplastic polymer, and about 1-50 wt %, including about 10-50 wt %, of a composition described herein.

In some embodiments, the polymeric blend of the thermoplastic polymer and sulfur copolymer may be prepared by solution blending, melt processing, or co-extrusion. In some embodiments, the thermoplastic polymer may include polyethylene, polypropylene, polyvinyl chloride, polystyrene, polyester, polycarbonate, polyamide, polycarbonate, or poly (methyl methacrylate). In yet other embodiments, the flame resistant substrate may further include a flame retardant filler that can enhance char formation.

According to some embodiments, the present invention features a coating composition for a fire retardant intumescent coating. The composition may include any one of the polymers described herein. In preferred embodiments, the coating composition provides for test specimens that are coated with the intumescent coating to exhibit an LOI of at least 25 and a UL94-V rating of V-2, V-1 or V-0. When a substrate coated with said intumescent coating is on fire, the intumescent coating forms a charring layer on a surface of the substrate. The charring layer is effective for extinguishing and preventing the spread of the fire by preventing oxygen from fueling the fire. In some embodiments, the coating may also be deposited by layer-by-layer deposition methods to form thin-layered coatings.

According to another embodiment, the present invention features a fire retardant composition comprising any one of the polymers described herein. Preferably, the fire retardant composition provides for test specimens that are combined with the fire retardant composition to exhibit an LOI of at least 25 and a UL94-V rating of V-2, V-1 or V-0. When a substrate combined with the fire retardant composition is on fire, the fire retardant composition forms a charring layer on a surface of the substrate, effective for extinguishing and preventing spread of the fire. In one embodiment, the charring layer includes at least about 20 wt % char.

In other embodiments, the compositions described herein may further include binders, fillers, or combinations thereof that are flame retardant and can enhance char formation. Suitable binders include organic binders, inorganic binders, and mixtures of these two types of binders. For example, the organic binders may be provided as a solid, a liquid, a solution, a dispersion, a latex, or similar form. The organic binder may include a thermoplastic or thermoset binder, which after cure is a flexible material. Other embodiments of the filler material may include clay materials, such as bentonite or kaolinite, and fiber materials, such as ceramic fibers and polycrystalline fibers.

In yet another embodiment, the present invention features a method of enhancing char formation in a substrate. The method may include combining a base material with a fire retardant composition to form the substrate. Preferably, the substrate exhibits an LOI of at least 25 and a UL94-V rating of V-2, V-1 or V-0. In other embodiments, the fire retardant composition includes a polymer blend of the thermoplastic polymer and the polymeric composition described herein. In other embodiments, the fire retardant composition includes a polymer blend of the thermoplastic polymer and any one of the polymers described herein. Without wishing to limit the present invention, the fire retardant composition is effective in forming a charring layer on the substrate when the substrate is on fire. The charring layer can extinguish and prevent the fire from spreading. In some embodiments, the charring layer may include at least 20 wt % char. For example, the charring layer may include at least 25 wt % char or 30 wt % char.

In some embodiments, the step of combining the base material with the fire retardant composition includes coating the base material with a coating including the fire retardant composition. In other embodiments, the step of combining the base material with the fire retardant composition includes depositing the fire retardant composition on the surface of the base material. In still other embodiments, the step of combining the base material with the fire retardant composition may include mixing monomers of the base material with monomers of the fire retardant composition to form a co-monomer mixture, polymerizing the co-monomer mixture to form a flame resistant polymer, and molding the flame resistant polymer to a shape of the substrate.

Another embodiment of the present invention may feature a method of forming a flame retardant-treated polymeric article. The method may include providing a polymeric base substrate, providing a flame retardant material comprising any of the flame retardant compositions described herein, and depositing the flame retardant material on at least a portion of an outer surface of the polymeric base substrate to form the flame retardant-treated polymeric article. Preferably, the flame retardant-treated polymeric article provides for test specimens that exhibit an LOI of at least 25 and a UL94-V rating of V-2, V-1 or V-0. Preferably, when the flame retardant-treated polymeric article is on fire, the flame retardant material forms a charring layer on the flame retardant-treated polymeric article to extinguish the fire. The charring layer may include at least 20 wt % char.

Alternate embodiments of the present invention may feature a method of forming a flame resistant composite. The method may include providing a flame retardant material including any of the flame retardant compositions described herein, providing a base material, and mixing the flame retardant material with the base material to form the flame resistant composite. The flame retardant material can enhance char formation when flame resistant composite is on fire. In some embodiments, the composite may include between about 1 to 20 wt % of the flame retardant material. For example, the composite may include about 10 wt % of the flame retardant material. In some embodiments, the base material is a polymeric material.

Sulfenyl chlorides are a widely known but largely ignored class of sulfur compounds that are highly reactive toward nucleophiles and electrophilic unsaturated compounds. Sulfenyl chlorides are closely related to organosulfur thiol and mercaptan molecules where the R—S—H bond is replaced via chlorination reactions to form the R—S—Cl, which constitutes the sulfenyl chloride moiety. The S—Cl functional group is dipolar covalent in nature and can be considered a strong electrophile for attack by nucleophilic compounds such as, alcohols/alkoxides, Grignard reagents, organolithium reagents to form various organodisulfide compounds.

One particular illustrative example of methods of the invention is an electrophilic addition of (organo)sulfenyl chlorides to unsaturated compounds, which primarily comprise alkenyl and alkynyl molecules such as vinylics, styrenics, acrylates, allylics, cyclic olefins, and both internal and terminal alkynes. The electrophilic addition of organosulfenyl chlorides, such as, benzenesulfenyl chloride (Ph-S—Cl) to strained cyclic olefins, such as, norbornene has been extensively studied, where the mechanism is proposed to proceed via ionic processes through episulfonium intermediates, followed by addition of the chloride anion with anti-stereochemistry to form organosulfur halides. These reactions proceed spontaneously in solution, in the bulk (i.e., neat) and can be done at very low temperatures (T˜−78° C.). The electrophilic addition of sulfenyl chlorides to unsaturated compounds is a close cousin to “thiol-ene addition reaction” of thiols to unsaturated compounds, but has mechanistic differences and distinctive functional group tolerances which offer unique opportunities for application to the synthesis of advanced polymeric materials.

This class of organosulfur compounds is largely based on derivatives of organothiols and organodisulfides since sulfenyl chlorides are typically prepared by direct chlorination of these compounds (using sulfuryl chloride, or N-chlorosuccinimide). These routes largely have been reported to afford organosulfenyl chlorides with monofunctional R—S—Cl motifs where the R-group is typically aliphatic, or aromatic thiophenol type compounds. Wholly inorganic families of sulfenyl chlorides have been made and widely used, which include sulfur dichloride (SCl₂), sulfur monochloride (S₂Cl₂) which also adds with high efficiency/potency to unsaturated olefinic molecules. S₂Cl₂ in particular has a long history of use in crosslinking/vulcanization of natural rubber, styrene-butadiene rubber, butyl rubber, where addition of this sulfenyl chloride is so exothermic that very cold temperatures must be used to make the crosslinked rubber, which is referred to as “cold vulcanization.” There have been only a few publications on the use of sulfur monochloride as a comonomer for making polymers, which include copolymerizations with butadienes and cyclic olefins. Unfortunately, these earlier works did not provide any useful polymers but mainly afforded intractable polymers with limited utility. It appears these disappointing results may have played a large role in discouraging others from further pursuing usefulness of chalcogenide halides for producing polymers. However, undiscouraged by these earlier results, the present inventors sought to take advantage of a high reactivity of chalcogenide halides to produce commercially useful organochalcogen polymers. At least a part of the invention is based on the discovery of useful reaction conditions by the present inventors in utilizing chalcogenide halides to produce commercially useful organochalcogen polymers. Accordingly, methods and processes disclosed herein provide heretofore unattainable organochalcogen polymers that have various useful and/or desirable physical properties for use as flame retardants.

As stated throughout this specification, other chalcogenide halides can also be used including, but not limited to, tellurium halides, selenium, mono-, di-, or tetrahalides, such as selenium dichloride (SeCl₂), selenium monochloride (Se₂Cl₂), and selenium tetrachloride (SeCl₄). These chalcogen halides undergo similar reactivity to the inorganic sulfur halide family of molecules to provide tellurium-containing organochalcogen polymers and selenium-containing organochalcogen polymers.

The addition of sulfenyl chlorides can be considered a “Click” type reaction that is a highly efficient thermodynamically driven addition reaction as observed for the alkynesazides, thiols-enes, and alcohols and isocyanates. S—Cl Click reactions can be similarly achieved by the functionalization of polymers with S—Cl groups and reacting with a 2nd disparate polymer that carries reactive unsaturated groups. The following describe some examples of these types of reactions.

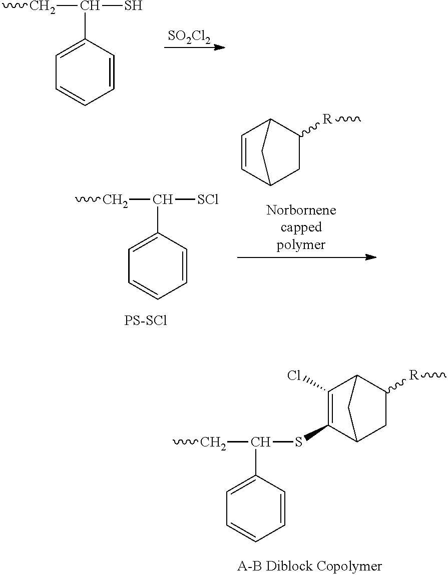

A polystyrene, or any polymer that carries a single thiol can be converted to a SCI end group by chlorination, e.g., with SO₂Cl₂, and reacted with a 2nd end-functional polymer that carries a vinyl end group, a cyclic olefin end group, an alkyne end group, or other carboncarbon unsaturated bond, where the S—Cl addition to the olefinic, or alkynyl end group results in a block copolymer synthesis. Thiol end-functional polymers can be readily prepared using controlled radical polymerizations, such as, atom transfer radical polymerization (ATRP), or Reversible Addition Fragmentation Chain Transfer (RAFT) polymerizations, using either functionally protected initiators, or by end-group transformations. Disulfide initiators for ATRP and RAFT can also be used to form polymers that after chlorination reactions cleaves the S—S bonds to install S—Cl end groups. Conversely, norbornene or vinyl end groups can be installed by use of functional initiators or end group modifications using methods known to one skilled in the art.

The mono-functional S—Cl whether on small molecules, or polymers as reactive end-groups can readily add to the internal olefins of polydienes, such as, polybutadiene, polyisoprene and polynorbornenes. The example provided shows the reaction of benzene sulfenyl chloride (Ph-S—Cl) adding to polybutadiene, which installs both Ph-S and —Cl groups across the double bond. Since the S—Cl group attaches to a wide range of molecules and polymers, this route offers a new route to polydiene modification.

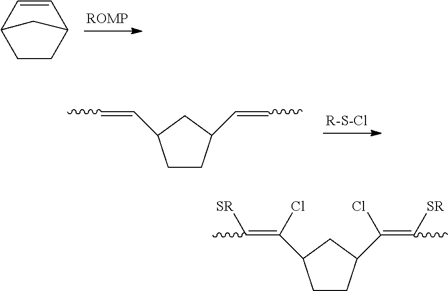

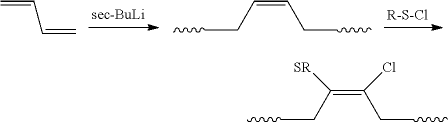

Difunctional sulfenyl chloride compounds can be used as comonomers with divinyl, di-olefinic, di-alkynyl comonomers to achieve A2+B2 step growth polymerization. Commercially available dithiols are typically thiophenolic compounds such as, 4,4-thiobisbenzenethiol, benzene-dithiols (both 1,3 an 1,4 isomers), or aliphatic dithiols (e.g., 1,2-decanedithiol), which can be readily chlorinated to make an A2-type disulfenyl chloride monomer. Macromonomers can be prepared by chlorinating dithiol prepolymers and oligomers that include poly(ethylene glycol), poly(dimethylsiloxane)(PDMS). This polymerization is a high addition polymerization with any divinyl, multi-vinyl, multi-unsaturated compound which include norbornadiene, norbornene derivatives, styrenics, acrylates, vinylics either as small molecule comonomers, or macromonomers.

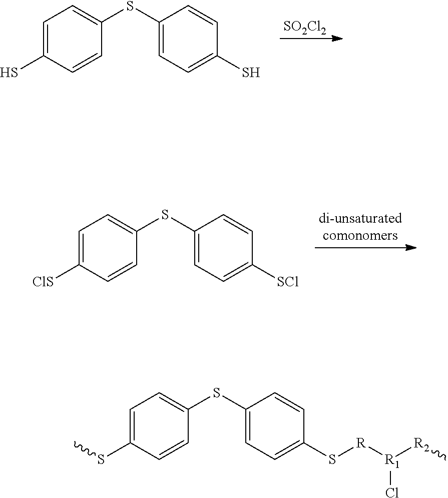

Exemplary di-unsaturated comonomers include, but are not limited to, the following alkenes and alkynes:

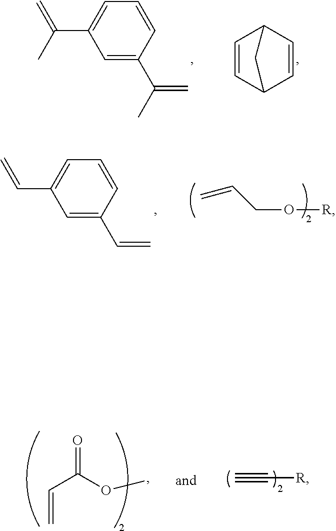

Sulfur monochloride (S₂Cl₂) is an inexpensive chemical that is industrially produced for various applications in the rubber industry. This compound is stable under ambient conditions and highly miscible with conventional organic solvents and organic comonomers such as vinylics, styrenics, acrylates, norbornenes, cyclic olefins, alkynes. Furthermore, the compound is wholly made of S—Cl groups which can serve as an A2-type step growth monomer that can deliver a controlled polymerization of disulfide when paired with a di-, or multiunsaturated organic comonomer. The sulfur monochloride polymerization with activated olefins which include norbornadienes (NBD), norbornenes, cyclic olefins, vinylics, styrenics, acrylates are highly reactive, exothermic reactions and are typically conducted in solution and/or at low temperature (e.g., T=−78° C. to 0° C.). Allylic monomers are more stable when mixed with sulfur monochloride at room temperature and because of this chemical stability are useful monomers with sulfur monochloride to perform bulk polymerizations at elevated temperatures (T=50-100° C.).

Use of sulfur monochloride instead of liquid sulfur has numerous advantages since elemental sulfur/liquid sulfur requires high reaction temperatures (e.g., typically reaction temperature in the range of 120° C. to 180° C.) and has limited miscibility with organic comonomers. In contrast, sulfur monochloride is readily miscible with organic media, can react with a much wider range of organic comonomers over a wider range of conditions (e.g., in bulk, solution, high or low T). One of the properties of resulting organochalcogen polymers of the invention in using sulfur monochloride vs elemental sulfur is the lower total incorporation of sulfur/chalcogenide moieties (disulfide S—S vs longer chains SS bonds), which may affect bulk properties.

The present invention, thus generally described, will be understood more readily by reference to the following examples, which are provided by way of illustration and are not intended to be limiting of the present invention.

### EXAMPLES

The following examples more specifically illustrate protocols for preparing compounds and devices according to various embodiments described above. These examples should in no way be construed as limiting the scope of the present technology.

One of the plastics achieved using methods of the invention, e.g., by the S—Cl inverse vulcanization, has been the polymerization of S₂Cl₂ with diallylic comonomers, such as, 1,3-diallyl isophthalate; 1,4-diallyl terephthalate; and diallyl bisphenol A based comonomers. These polymerizations proceeded very efficiently in bulk at a reaction temperature of about T=50° C. to high conversion. Molar masses of the resulting polymers range from about 2000 to about 20,000 g/mol. However, depending on the reaction conditions, molar masses can be readily increased up to about 1,000,000 g/mol. These new polymers, particularly those made from diallyl terephthalates are excellent commodity engineering plastics comparable to or superior to polyethylene terephthalate (PET) and polycarbonates.

### Synthesis of Poly(S₂-DAI-Cl₂) with Sulfenyl Chloride Inverse Vulcanization

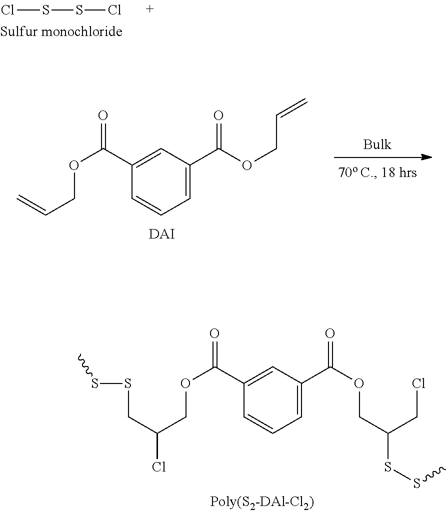

To a 10 mL vial equipped with a magnetic stir bar was added sulfur monochloride (S₂Cl₂, 1.688 g, 1 mL, 0.0125 mole) and diallyl isophthalate (3.078 g, 2.72 mL, 0.0125 mole) at T=70° C. in a thermostated oil bath. The reaction mixture was stirred at 500 rpm for 18 hours until vitrification. After vitrification of poly(S₂-DAI-Cl₂), the reaction mixture was cooled to room temperature. A yellowish glassy polymer was dissolved in 15 mL of tetrahydrofuran, and precipitated in 30 mL of methanol, which induced dissolution of unreacted sulfur monochloride and diallyl isophthalate for purification. This purification process was conducted 3 times. The collected products were then dried at 60° C. under vacuum affording a white solid. Yield=3.56, g, Mn=20,700 g/mol, PDI=1.96.

### Synthesis of Poly(S₂-Triallyl Isophthalate-Cl₂) with Chalcogenide Halide Inverse Vulcanization

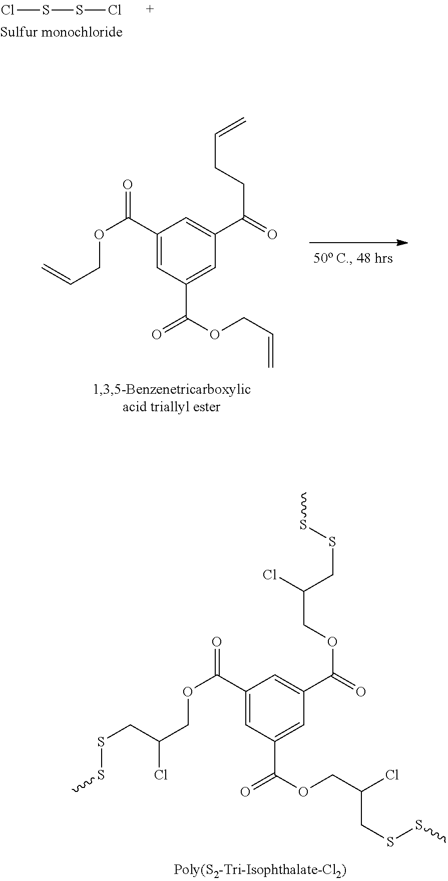

To a 10 mL vial equipped with a magnetic stir bar was added sulfur monochloride (S₂Cl₂, 0.2026 g, 0.12 mL, 0.0015 mole) at T=50° C. in a thermostated oil bath. 1,3,5-benzenetricarboxylic acid triallyl ester powder (0.5162 g, 0.00156 mole) was dissolved in 5 mL of THF and injected into the vial. The reaction mixture was stirred at 500 rpm for 48 hours. The reaction mixture was cooled to room temperature. A yellowish polymer solution was precipitated in 10 mL of methanol. The precipitated polymer was then re-dissolved in 5 mL of THF and precipitated in 10 mL of methanol. This purification process was conducted 3 times, which induced the dissolution of unreacted reagents and oligomers for the purification. The collected products were then dried at 60° C. under vacuum affording a yellowish solid. (yield=0.5032 g, Mn=2,700 g/mol, PDI=1.31).

Reaction of S₂Cl₂ with 1,3-diethynylbenzene: To a 2 mL scintillation vial equipped with a magnetic stir bar was added 1,3-diethynylbenzene (0.49 mL, 3.85 mmol) and S₂Cl₂ (0.52 mL, 3.85 mmol). The reaction was allowed to stir for 18 hours at room temperature at which point the reaction was heated to 50° C. for 5 hours. The dark red solid was removed from the vial by scoring it with a diamond knife and breaking the vial (yield, 1.00 g).

Reaction of S₂Cl₂ with 1,3,5-triethynylbenzene: To a 2 mL scintillation vial equipped with a magnetic stir bar was added 1,3,5-triethynylbenzene (55.5 mg, 0.29 mmol) and S₂Cl₂ (0.02 mL, 0.29 mmol). Toluene was then added dropwise until the solution was soluble (˜0.1 mL). The contents of the vial were stirred at room temperature for 18 hours. The reaction was then placed under vacuum to remove the toluene. The vial was then placed in a vacuum oven at 50° C. to remove any remaining toluene. The vial was removed from the vacuum oven resulting in a brittle, yellow solid.

### Synthesis of High Molecular Weight Poly(S₂-Diallyl Isophthalate-Cl₂) (Poly(S₂-DAI-Cl₂))

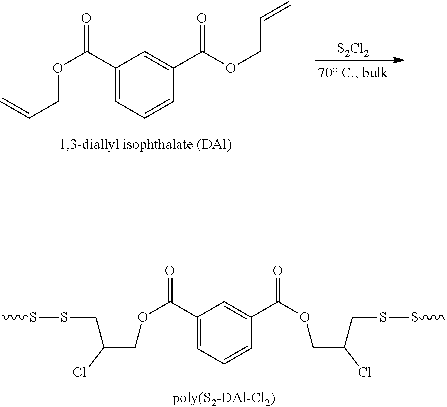 [0105] To a 20 ml scintillation vial equipped with a magnetic stir bar was added sulfur monochloride (S₂Cl₂, 0.506 g, 0.3 mL, 0.00375 mole) and diallyl isophthalate (DAI, 0.924 g, 0.82 ml, 0.00375 mole). The vial was placed in a thermostated oil bath preset at 60° C. and stirred at 500 rpm until the mixture vitrified. After vitrification, the polymer mixture was cooled to room temperature affording a yellowish glassy polymer. The glassy polymer mixture was dissolved in 10 mL anhydrous THF and precipitated in 30 mL of methanol to induce the removal of unreacted S₂Cl₂ and DAI. The purification process was conducted 3 times, and the collected solid polymer was then dried at 60° C. under vacuum affording a white powder. (Yield=1.18 g, Mn=38,000 g/mol, PDI=2.14, CHS Elemental Analysis: C=43.79%, H=4.26%, S=17.14%)

The poly(S₂-DAI-C12) obtained from the above procedure had a Mn=82,000 and Mw/Mn=1.7, which where confirmed by THF-SEC. 1H NMR spectroscopy of the poly(S₂-DAI-Cl₂) and model reactions of S₂Cl₂ with allyl benzoate indicates a 60:40 molar ratio of (—SS—CH₂—CHR—Cl) vs (—SS—CHR—CH₂—Cl) regiosomer units were formed from this polymerization, along with stereoisomers formed by —CHR—S— and —CHR—CI fragments. The chemical stability of DAI in S₂Cl₂ solutions also indicates that allylic monomers can be safely mixed with S₂Cl₂ for bulk polymerizations and then heated to elevated temperatures, which is amenable to meltprocessing for a variety of applications. TGA of the isolated poly(S₂-DAI-Cl₂) powder indicated thermal stability until around T_{decomp}˜300° C., which confirmed that the β-halothioether and disulfide units of these polymers exhibited acceptable thermal stability that was comparable to other known polymers, such as, PMMA and poly(vinyl chloride (PVC) that decompose at similar temperatures. DSC of the isolated poly(S₂-DAI-Cl₂) detected a single Tg=35° C. indicating that an amorphous material was prepared.

### Synthesis of High Molecular Weight Poly(S₂-Diallyl Tetrabromo-Bisphenol A-Cl₂) (Poly(S₂-DABr₄BPA-Cl₂))

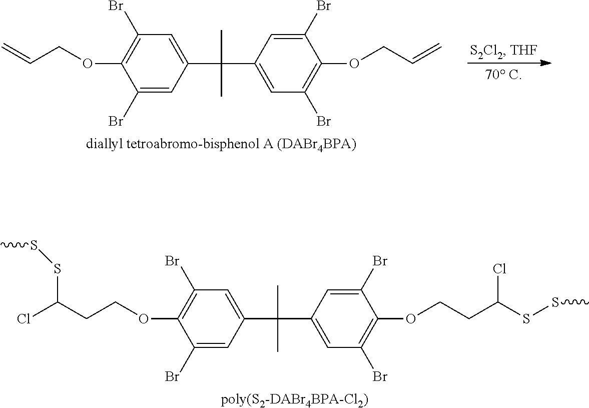

To a 20 mL vial equipped with a magnetic stir bar was added diallyl tetrabromo bisphenol A (DABr₄BPA, 1.560 g, 0.0025 mole) in 1 mL of anhydrous toluene, sulfur monochloride (S₂Cl₂, 0.338 g, 0.2 mL, 0.0025 mole) was then injected into the solution at the room temperature. The vial was placed in a thermostated oil bath preset at 60° C. and stirred at 500 rpm until the mixture vitrified. After vitrification, the polymer mixture was cooled to room temperature affording a yellowish glassy polymer. The glassy polymer mixture was dissolved in 10 mL anhydrous THF and precipitated in 30 mL of hexane to induce the removal of unreacted S₂Cl₂ and DABr₄BPA. The purification process was conducted 3 times, and the collected products were dried at 60° C. under vacuum affording a white powder. (Yield=1.624 g, Mn=102,000 g/mol, PDI=2.2, CHS Elemental Analysis: C=34.77%, H=3.12%, S=10.12%).

The poly(S₂-DABr₄BPA-Cl₂) obtained from the above procedure had a Mn=102,000 and Mw/Mn=2.2. TGA of the isolated poly(S₂-DABr₄BPA-Cl₂) powder indicated thermal stability until around T_{decomp}<238° C. The Tg of the isolated poly(S₂-DAI-Cl₂) was detected Tg˜76° C.

### Synthesis of High Molecular Weight Poly(S₂-Triallyl Isocyanurate-Cl₂) (Poly(S₂-TIC-Cl₂))

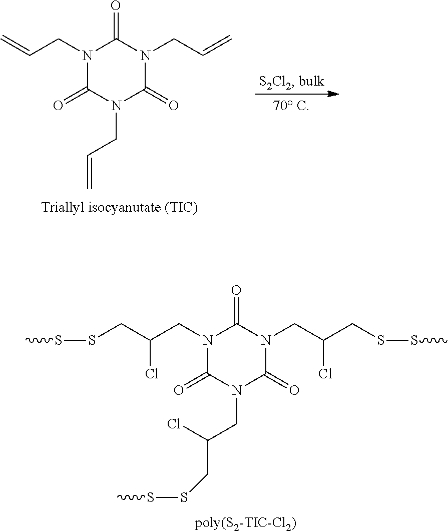

To a 20 mL vial equipped with a magnetic stir bar was added sulfur monochloride (S₂Cl₂, 1.688 g, 1 mL, 0.0125 mole) and triallyl isocyanurate (2.8326 g, 2.444 mL, 0.0113636 mole) to T=50° C. in a thermostated oil bath. The reaction mixture was stirred by 500 rpm until the high viscosity. The magnetic stir bar was removed from the reaction vial for the fabrication of the window. The reaction temperature was then increased to 70° C. for 24 hours. Then, the reaction mixture in vial was placed in 120° C. convection oven. The yellowish window was then collected from the vial.

TGA of the isolated poly(S₂-TIC-Cl₂) powder indicated thermal stability until around T_{decomp}<256° C. The Tg of the isolated poly(S₂-TIC-Cl₂) was detected Tg˜93° C.

### Synthesis of High Molecular Weight Poly(S₂-Triallyl Isocyanurate-Diallyl Tetrabromo-Bisphenol A-Cl₂) (Poly(S₂-TIC-DABr₄BPA-Cl₂))

To a 20 mL vial equipped with a magnetic stir bar was added triallyl isocyanurate (TIC, 1.6226 g, 1.4 mL, 0.0065 mole) and diallyl tetrabromo-bisphenol A (DABr₄BPA, 0.8113 g, 0.0013 mole) to T=70° C. in a thermostated oil bath. The reaction mixture was stirred by 500 rpm until homogeneous. Sulfur monochloride (S₂Cl₂, 1.2655 g, 0.749 mL, 0.0093 mole) was then injected into the reactor. The magnetic stir bar was removed from the reaction vial for the fabrication of the window. The reaction temperature was then increased to 70° C. for 24 hours. Then, the reaction mixture in vial was placed in 120° C. convection oven. The yellowish window was then collected from the vial.

TGA of the isolated poly(S₂-TIC-DABr₄BPA-Cl₂) powder indicated thermal stability until around T_{decomp}>260° C. The Tg of the isolated poly(S₂-TIC-DABr₄BPA-Cl₂) was detected Tg˜89-90° C.

### Flame Retardant Properties of Sulfur-Containing Properties

The flame retardancy of these new polyhalodsulfides was interrogated by the UL-94V vertical flame test which is an established ASTM flame retardancy test for polymeric materials. See, Kim et al., Polymer Chemistry 2014, 5 (11), 3617-3623. The poly(S₂-DAI-Cl₂) sample were observed to rapidly self-extinguish within 10 secs and again for a 2nd ignition within 11 secs, without any underlying debris spreading fire to the underlying cotton, which afforded a V0 UL-94V rating which is the highest flame retardancy score with this assay. These assays provided compelling results indicating that the β-halodisulfide units in poly(S₂-DAI-Cl₂) are sufficient to impart flame retardant properties to the material (since the hydrocarbon isophthalate moiety is flammable), which we anticipate arises from a vapor-phase mechanism for self-extinguishment.

The poly(S₂-DABr₄BPA-Cl₂) sample also exhibited a V0-rating in the UL-94V flame test and similar self-extinguishment times as observed for poly(S₂-DAI-Cl₂). In this case, the flame retardant properties were attributed to a synergistic vapor-phase mitigation by both β-halodisulfide and Br₄BPA moieties in the polymer. Both of these flame test cases point to potential of these polyhalodisulfides to serve as candidate flame retardant polymers using inexpensive monomers which intrinsically exhibit flame retardant character, in contrast to many of the current approaches to prepare flame retardant polymers that require inclusion of specialized flame retardant functional units into classical polymer backbones.

### Other Exemplary Reactions:

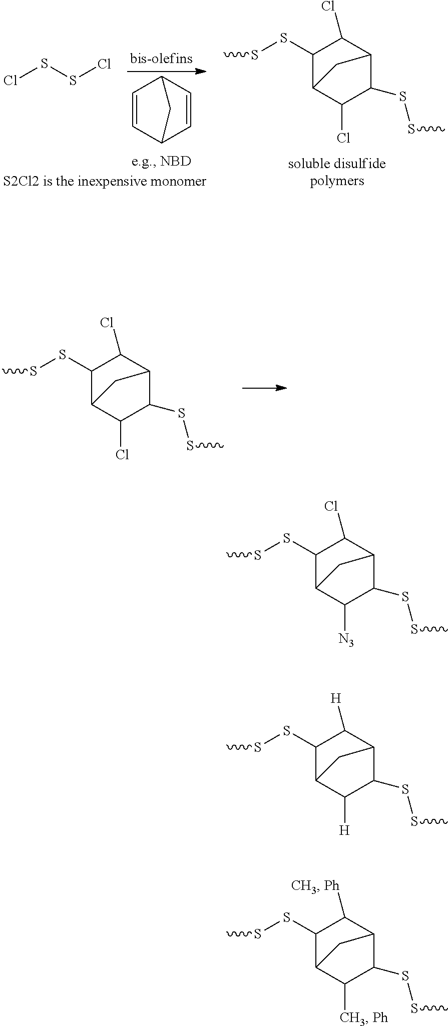

In some embodiments, Cl groups can be replaced with other reactive, or stable groups including, but not limited to, azide (e.g., using NaN₃) or other conventional side chain groups (e.g., alkyl, Ph-CH₃— group, etc. to modify Tg and/or solubility). Still in other embodiments, chloride can be replaced with hydrogen (e.g., by selective hydrogenation without cleaving S—S bond).

As discussed above, methods of the invention can also utilize other chalcogen halide such as selenium monochloride to produce a product that is similar to using sulfur monochloride:

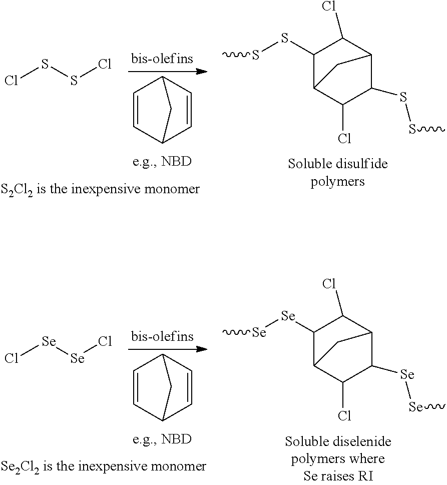

Other useful olefins include organic compounds shown below:

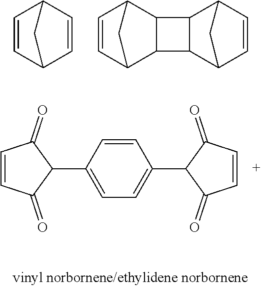

Using a selenium tetrahalide, such as selenium tetrachloride, produces crosslinked polymers as exemplified below.

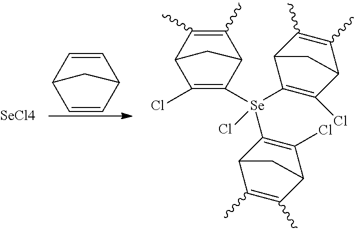

One can also increase the amount of sulfur in organochalcogen polymers of the present invention, for example, by utilizing the following process:

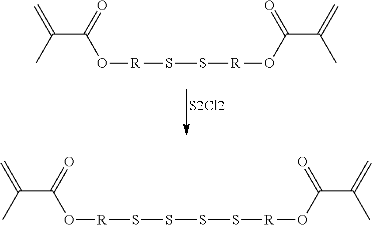

Such a process can be used to increase sulfur rank and sulfur content as some olefins, such as methacrylates, do not readily react with S—Cl. Similarly, one can also increase Se—S rank.

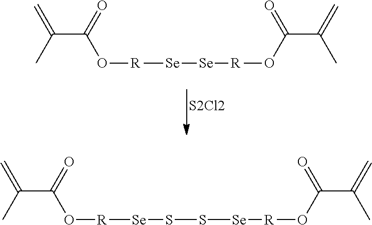

### EMBODIMENTS

Embodiment 1. A process for producing an organochalcogenide polymer, said process comprising admixing a monomeric mixture comprising: (i) a chalcogenide halide and (ii) an organic compound comprising an unsaturated carbon-carbon bond, under reaction conditions sufficient to produce said organochalcogenide polymer, wherein said chalcogenide halide is selected from the group consisting of sulfur monohalide, sulfur dihalide, selenium monohalide, selenium dihalide, selenium tetrahalide, and a combination thereof.

Embodiment 2. The process of Embodiment 1, wherein said chalcogenide halide is selected from the group consisting of sulfur monochloride, sulfur monobromide, selenium monochloride, selenium monobromide, selenium dichloride, selenium dibromide, selenium tetrachloride, selenium tetrabromide and a combination thereof.

Embodiment 3. The process of Embodiment 1 or Embodiment 2, wherein said chalcogenide halide is selected from the group consisting of sulfur monochloride, sulfur dichloride, selenium monochloride, selenium dichloride, selenium tetrachloride, and a combination thereof.

Embodiment 4. The process of any one of Embodiments 1-3, wherein said monomeric mixture is admixed in the presence of an organic solvent.

Embodiment 5. The process of Embodiment 4, wherein said organic solvent comprises a polar organic solvent, a non-polar aprotic organic solvent, or a combination thereof.

Embodiment 6. The process of Embodiment 5, wherein said organic solvent comprises tetrahydrofuran, toluene, benzene, xylene, chlorobenzene, dichlorobenzene, diethyl glycol, N,Ndimethylformamide, carbon disulfide, halogenated solvents such as dichloromethane, chloroform or a combination thereof.

Embodiment 7. The process of any one of Embodiments 1-6, wherein said unsaturated carbon-carbon bond comprises a carbon-carbon double bond, a carbon-carbon triple bond, or a combination thereof.

Embodiment 8. The process of any one of Embodiments 1-7, wherein said organic compound comprises vinyl, allyl, styrenic, α-methylstyrenic, (meth)acrylate, norbornenes, cyclic olefins, vinylogous sulfides and other substituted alkenes, substituted olefins, maleimides, maleic anhydrides.

Embodiment 9. The process of any one of Embodiments 1-8, wherein said organochalcogenide polymer is produced at a reaction temperature of about 200° C. or less.

Embodiment 10. The process of any one of Embodiments 1-9, further comprising purifying said organochalcogenide polymer.

Embodiment 11. The process of Embodiment 10, wherein said step of purifying said organochalcogenide polymer comprises the steps of:
(a) dissolving said organochalcogenide polymer in an organic solvent to produce a homogeneous solution;
(b) precipitating said organochalcogenide polymer to produce at least a partially purified organochalcogenide polymer; and
(c) optionally repeating steps (a) and (b).

Embodiment 12. The process of Embodiment 11, wherein said organochalcogenide polymer has a purity of at least 90%.

Embodiment 13. The process of any one of Embodiments 1-12, wherein a yield of said organochalcogenide polymer is about 50% or higher relative to the amount of said organic compound used.

Embodiment 14. The process of any one of Embodiments 1-13, wherein an amount of said chalcogenide halide used is about 80 mole % or less relative to an amount of said organic compound.

Embodiment 15. The process of any one of Embodiments 1-14, wherein said organic compound comprises at least two unsaturated carbon-carbon bonds.

Embodiment 16. The process of any one of Embodiments 1-15, wherein said organic compound comprises at least three unsaturated carbon-carbon bonds.

Embodiment 17. An organochalcogenide polymer produced from a process comprising admixing a monomeric mixture comprising:
(i) a chalcogenide halide and
(ii) an organic compound comprising an unsaturated carbon-carbon bond under reaction conditions sufficient to produce said organochalcogenide polymer,
   wherein said chalcogenide halide is selected from the group consisting of sulfur monohalide, sulfur dihalide, selenium monohalide, selenium dihalide, selenium tetrahalide, and a combination thereof.

Other embodiments are set forth in the following claims.

What is claimed is:

1. A flame retardant composition comprising a polymer that is a reaction product of a mixture of a chalcogenide halide and one or more organic compounds comprising an unsaturated carbon-carbon bond under reaction conditions sufficient to produce the polymer, wherein the chalcogenide halide comprises a sulfur monohalide, a sulfur dihalide, a selenium monohalide, a selenium dihalide, a selenium tetrahalide, or a combination of any two or more thereof.

2. The flame retardant composition of claim 1, wherein the chalcogenide halide is selected from the group consisting of sulfur monochloride, sulfur monobromide, selenium monochloride, selenium monobromide, selenium dichloride, selenium dibromide, selenium tetrachloride, selenium tetrabromide, and a combination of any two or more thereof.

3. The flame retardant composition of claim 1, wherein the chalcogenide halide is sulfur monochloride.

4. The flame retardant composition of claim 1, wherein the unsaturated carbon-carbon bond comprises a carbon-carbon double bond, a carbon-carbon triple bond, or a combination of any two or more thereof.

5. The flame retardant composition of claim 1, wherein the organic compound comprises at least two unsaturated carbon-carbon bonds.

6. The flame retardant composition of claim 1, wherein the organic compound comprises at least three unsaturated carbon-carbon bonds.

7. The flame retardant composition of claim 1, wherein the organic compound comprises a vinyl olefin, an allyl olefin, a styrenic olefin, an α-methylstyrenic olefin, a (meth)acrylate olefin, a norbornene, a cyclic olefin, a vinylogous sulfide, a substituted alkene olefin, a maleimide, a maleic anhydride, or a combination of any two or more thereof.

8. The flame retardant composition of claim 1, wherein the organic compound comprises a terephthalate, an isophthalate, a bisphenol A or derivative thereof, 4,4-methylene diphenyl (MDI), a trifunctional terephthalate, a tris-phenolic core, a isocyanurate, a phosphazene, a siloxane, a isocorbide, a naturally occurring product, or a combination of any two or more thereof.

9. The flame retardant composition of claim 8, wherein the organic compound comprises 1,3-diallyl isophthalate (DAI), diallyl tetrabromo-bisphenol A (DABr₄BPA), triallyl isocyanurate (TIC), or a combination of any two or more thereof.

10. The flame retardant composition of claim 1, wherein the polymer is produced by a process comprising admixing a monomeric mixture comprising the chalcogenide halide and the one or more organic compound comprising an unsaturated carbon-carbon bond under suitable reaction conditions.

11. The flame retardant composition of claim 10, wherein the monomeric mixture is admixed in the presence of an organic solvent.

12. The flame retardant composition of claim 10, wherein the process is conducted at a reaction temperature of about 200° C. or less or about 100° C. or less.

13. The flame retardant composition of claim 12, wherein the process is conducted at a reaction temperature of from about 50° C. to about 100° C.

14. The flame retardant composition of claim 10, wherein the monomeric mixture further comprises one or more elemental sulfur derived copolymers, such as a poly(sulfur-random-styrene).

15. The flame retardant composition of claim 1, wherein when a substrate combined with the flame retardant composition is ignited to be on fire, the fire retardant composition forms a charring layer on a surface of the substrate that is effective for extinguishing the fire.

16. The flame retardant composition of claim 15, wherein the charring layer comprises at least about 10 wt % char.

17. The flame retardant composition of claim 1, wherein the flame retardant composition provides for test specimens that are combined with the flame retardant composition to exhibit a limiting oxygen index (LOI) of at least 25 and/or a UL94-V rating of V-2, V-1 or V-0.

18. The flame retardant composition of claim 1, wherein the flame retardant composition has a low heat release capacity (e.g., <400 J/gK as determined from microcombustion calorimetry).

19. A flame resistant substrate comprising a base material combined with the flame retardant composition of claim 1.

20. A process for producing a flame retardant composition of claim 1, comprising admixing a monomeric mixture comprising a chalcogenide halide and an organic compound comprising an unsaturated carbon-carbon bond under reaction conditions sufficient to produce the polymer, wherein said chalcogenide halide comprises a sulfur monohalide, a sulfur dihalide, a selenium monohalide, a selenium dihalide, a selenium tetrahalide, or a combination of any two or more thereof.
